(19) United States
(12) Patent Application Publication
(10) Pub. No.: US 2009/0144783 A1
(43) Pub. Date: Jun. 4, 2009

(54) Broadcast receiver and method for receiving adaptive broadcast signal

(76) Inventors: Joon Hui Lee, Seoul (KR); Jong Yeul Suh, Seoul (KR)

Correspondence Address: MCKENNA LONG & ALDRIDGE LLP, 1900 K STREET, NW, WASHINGTON, DC, 20006, US

(21) Appl. No.: 12/292,878

(22) Filed: Nov. 28, 2008

Related U.S. Application Data
(60) Provisional application No. 60/991,204, filed on Nov. 29, 2007.

(51) Int. Cl. H04N 7/173

(52) U.S. Cl. 725/93; 725/105

(57) ABSTRACT

A broadcast receiver and method for receiving an adaptive broadcast signal are disclosed. The present invention includes a network interface unit transmitting/receiving an IP packet via a network, a display unit displaying a broadcast signal included in the IP packet, a control unit controlling an available service information list including size information of a program broadcasted from a service provider to be displayed, the available service information list included in the IP packet, the control unit selecting a target bitrate from the size information included in the available service information list, the control unit controlling the selected target bitrate to be sent to the service provider, and a service control manager controlling a reception of the program having the sent target bitrate.

This application claims the benefit of U.S. Provisional Application No. 60/991,204, filed on Nov. 29, 2007, which is hereby incorporated by reference.

### BACKGROUND OF THE INVENTION

1. Field of the Invention

The present invention relates to an apparatus for receiving an adaptive broadcast signal and method thereof.

2. Discussion of the Related Art

FIGS. 1A to 1C show a broadcast receiving method according to a related art.

Referring to FIGS. 1A to 1C, in a related art TV, contents provided by a broadcasting station are transmitted via a radiowave transferring medium such as a broadcast network and the like by a cable broadcast provider, a terrestrial broadcast provider or a satellite broadcast provider. A viewer receives a corresponding service in a manner of viewing the contents via a TV receiver capable of receiving each of the transfer media.

As the digital based TV technology has been developed and commercialized from the conventional analog TV broadcasting, various contents including real-time broadcasting, CoD (contents on demand), games, news and the like can be provided to viewers via Internet networks connected to home as well as the conventional radiowave media.

As an example of the contents providing via the internet network, there is an internet protocol TV (IPTV). The IPTV means a service for providing information services, moving picture contents, broadcasts and the like to a television using high-speed internet networks.

The IPTV is identical to normal cable broadcasting or satellite broadcasting in providing broadcast contents including video. Yet, the IPTV is characterized in having bi-directionality in addition. Differing from terrestrial broadcasting, cable broadcasting or satellite broadcasting, the IPTV enables a user to view a specific program at a specific time convenient to the user.

Meanwhile, a broadcast receiver has a supported display status value varying according to performance thereof. And, a requested display status value varies according to a display type as well.

However, it frequently happens that contents provided by contents providers are uniformly received to increase a service information size unnecessarily.

### SUMMARY OF THE INVENTION

Accordingly, the present invention is directed to an apparatus for receiving an adaptive broadcast signal and method thereof that substantially obviate one or more problems due to limitations and disadvantages of the related art.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

An object of the present invention is to provide a broadcast receiver and method of receiving an adaptive broadcast signal therein, by which an adaptive broadcast signal suitable for resources of the broadcast receiver can be received.

Another object of the present invention is to provide a broadcast receiver and method of receiving an adaptive broadcast signal therein, by which an adaptive broadcast signal suitable for resource statuses of the broadcast receiver can be provided.

To achieve these objects and other advantages and in accordance with the purpose of the invention, as embodied and broadly described herein, a method of receiving an adaptive broadcast signal includes the steps of: sending an available service information list including size information of a program broadcasted by a service provider via an IP network, receiving and displaying the sent available service information list, selecting a target bitrate from the size information of the program included in the received available service information list, sending the selected target bitrate to the service provider, and broadcasting the program having the sent target bitrate from the service provider.

Also, method further includes the step of sending remaining storage space information to the service provider. Herein, if a remaining storage space equal to or lower than a preset value exists, the remaining storage space information is sent.

Also, in the step of sending the available service information list, the available service information list is sent in at least one case selected from the group consisting of a push VOD (video on demand) service execution, a specific broadcast program broadcasting start and a specific program recording execution.

In another aspect of the present invention, a method of receiving an adaptive broadcast signal includes the steps of: receiving an available service information list including size information of a program broadcasted from a service provider via an IP network, displaying the received available service information list, selecting a target bitrate from the size information of the program included in the received available service information list, sending the selected target bitrate to the service provider, and receiving the program having the sent target bitrate.

Also, the method further includes the step of sending remaining storage space information to the service provider.

Also, if a remaining storage space equal to or lower than a preset value exists, the remaining storage space information is sent.

Also, in the step of receiving the available service information list, the available service information list is received in at least one case selected from the group consisting of a push VOD (video on demand) service execution, a specific broadcast program broadcasting start and a specific program recording execution.

In another aspect of the present invention, a method of receiving an adaptive broadcast signal includes the steps of: sending remaining storage space information to a service provider via an IP network, sending recording target program information to the service provider, selecting a target bitrate of the recording target program based on the sent remaining storage space information in the service provider, and broadcasting the program having the selected target bitrate from the service provider. Herein, the broadcasted program has an adaptive bitrate by a section unit.

In another aspect of the present invention, a method of receiving an adaptive broadcast signal includes the steps of: sending remaining storage space information to a service provider via an IP network, sending recording target program information to the service provider, and receiving a program having a target bitrate selected based on the sent remaining storage space information in the service provider. Herein, the received program has an adaptive bitrate by a section unit.

In another aspect of the present invention, a broadcast receiver includes a network interface unit transmitting/receiving an IP packet via a network, a display unit displaying a broadcast signal included in the IP packet, a control unit controlling an available service information list including size information of a program broadcasted from a service provider to be displayed, the available service information list included in the IP packet, the control unit selecting a target bitrate from the size information included in the available service information list, the control unit controlling the selected target bitrate to be sent to the service provider, and a service control manager controlling a reception of the program having the sent target bitrate.

Also, the broadcast receiver further includes a storage unit storing the program having the sent target bitrate.

Also, the control unit controls remaining storage service information of the storage unit to be sent to the service provider.

Also, if a remaining storage space equal to or lower than a preset value exists, the control unit controls the remaining storage space information to be sent.

Also, the available service information list is received in at least one case selected from the group consisting of a push VOD (video on demand) service execution, a specific broadcast program broadcasting start and a specific program recording execution.

Also, the control unit selects the target bitrate from the size information included in the available service information list based on a user's program selection signal.

In another aspect of the present invention, a broadcast receiver includes a network interface unit transmitting/receiving an IP packet via a network, a display unit displaying a broadcast signal included in the IP packet, a control unit controlling remaining storage space information of the storage unit and recording target program information to be sent to a service provider, and a service control manager controlling a reception of a program having a target bitrate selected based on the remaining storage space information. Herein, the program has an adaptive bitrate by a section unit.

Accordingly, the present invention provides the following effects and/or advantages.

First of all, a resource status is transmitted to a service provider and a content suitable for the resource statuses is received, outputted and stored. Therefore, the present invention enables a receiver-adaptive broadcast.

Secondly, in case that a storage space is insufficient, the present invention selective receives and stores a content suitable for the storage space.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIGS. 1A to 1C are diagrams for a broadcast receiving method according to a related art,

FIG. 2 is a diagram for system layers of IPTV (IP television),

FIG. 3 is a characteristic diagram for IPTV system,

FIG. 4 is a block diagram of a system between a service provider and a broadcast receiver,

FIG. 5 is a diagram for IP capsulation in case that a service provider provides a service to a broadcast receiver via an IP network,

FIG. 6 is a flowchart for a method of receiving an adaptive broadcast signal according to a first embodiment of the present invention,

FIG. 7 is a diagram for operations between a service provider and a broadcast receiver according to one preferred embodiment of the present invention in a method of receiving an adaptive broadcast signal according to a first embodiment of the present invention,

FIG. 8 is a flowchart for a method of receiving an adaptive broadcast signal according to a second embodiment of the present invention,

FIG. 9 is a diagram for operations between a service provider and a broadcast receiver according to one preferred embodiment of the present invention in a method of receiving an adaptive broadcast signal according to a second embodiment of the present invention,

FIG. 10 is a diagram for operations between a service provider and a broadcast receiver according to another preferred embodiment of the present invention in a method of receiving an adaptive broadcast signal according to a first embodiment of the present invention,

FIG. 11 is a diagram for operations between a service provider and a broadcast receiver according to another preferred embodiment of the present invention in a method of receiving an adaptive broadcast signal according to a second embodiment of the present invention,

FIG. 12 is a diagram of a data structure for sending resource information of a broadcast receiver to a service provider from the broadcast receiver according to one embodiment of the present invention,

FIG. 13 is a diagram of a data structure for sending remaining storage space information of a broadcast receiver to a service provider from the broadcast receiver according to one embodiment of the present invention,

FIG. 14 is a diagram of a data structure for sending remaining storage space information of a broadcast receiver to a service provider from the broadcast receiver according to another embodiment of the present invention, and

FIG. 15 is a block diagram of a broadcast receiver according to an embodiment of the present invention.

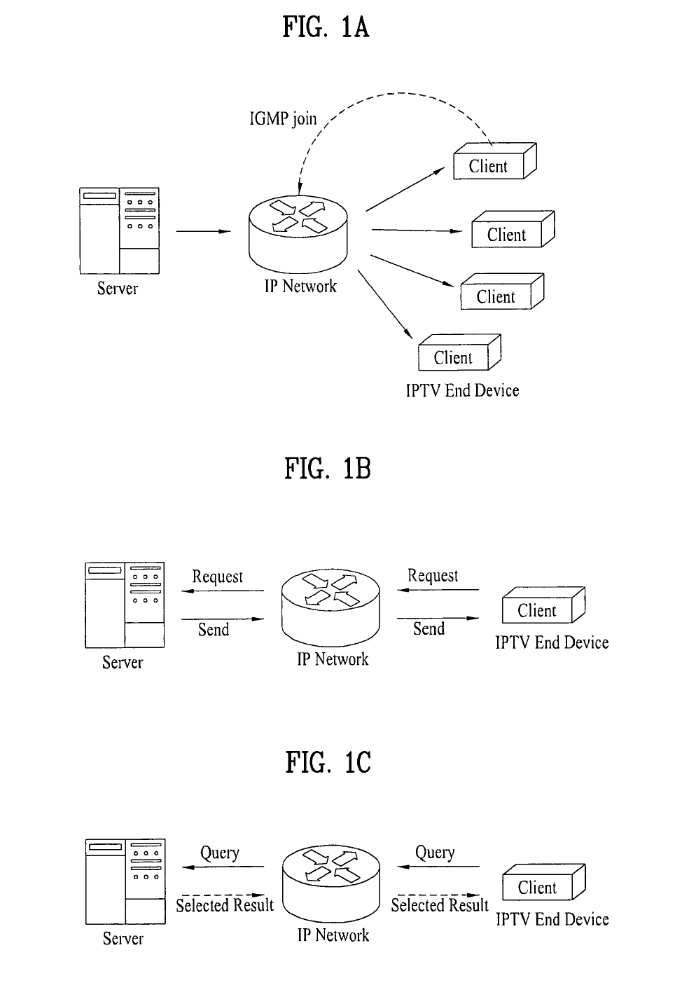

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

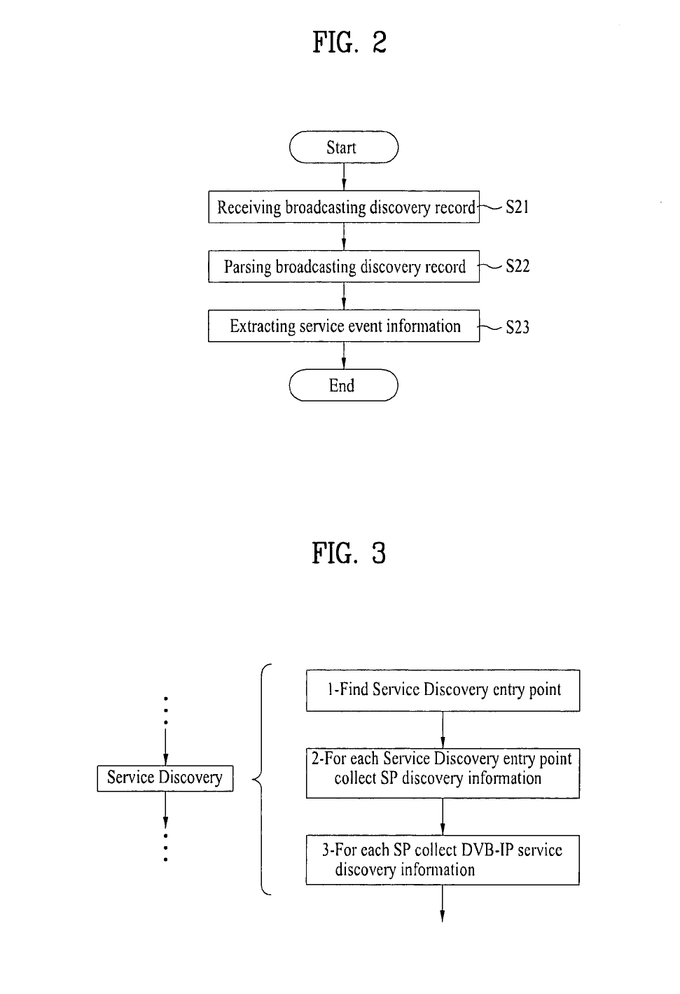

FIG. 2 is a diagram for system layers of IPTV (IP television).

Referring to FIG. 2, an IPTV system includes a contents provider layer, a service provider layer, a network provider layer, and a consumer layer.

The contents provider plays a role in providing the service provider with contents.

The service provider plays a role in providing a service to a subscriber. And, the service provider collects various contents, transforms signals to fit an IP environment, and then delivers the transformed signals to the consumer. In this case, the service provider may correspond to a virtual existence and the contents provider can be the service provider.

The network provider plays a role in connecting the consumer and the service provider together via IP network.

A transport system can use various networks including an access network, a backbone network, etc. The consumer is the layer for receiving a broadcast by being provided with contents. And, the consumer includes a set-top box, a personal computer (PC), a mobile terminal or the like.

A concept of the IPTV is explained in detail in the following description.

FIG. 3 is a characteristic diagram for IPTV system.

Referring to FIG. 3, system layers of IPTV can be mainly categorized into a contents provider, a service provider, and a consumer. The contents provider can be called a platform provider as well. The three kinds of groups play different roles, respectively.

The contents provider can indicate a group that provides overall services and data for broadcast programs.

The service provider transmits multimedia data. The service provider provides the consumer with maintenance and management to enable stable reception of contents. And, the service provider provides the contents provider with the infrastructure and functions for capability of network transmission.

And, the consumer group plays a role in playing data inputted using such an infrastructure as XDSL, cable and the like or responding to a user request promptly. The consumer group mostly includes manufacturers for manufacturing IPTVs and its kinds can be categorized into IPTV, IP STB, IP Phone, and the like. The respective groups are explained in detail as follows.

First of all, the contents provider group may include a TV station that produces a broadcast program. The TV station means a conventional terrestrial broadcasting station or a cable broadcasting station. These broadcasting stations produce and store programs viewable by consumers and are capable of converting the programs digitally to be transmitted. This is to enable various broadcasting types to be transmitted.

A radio station means a general radio broadcasting station and may have a video channel in some cases. Yet, the radio station is mostly operated without video channel. VoD (video on demand) or AoD (audio on demand) service has characteristics different from those of the TV station or the radio station.

The contents provider may store and keep a program to be broadcasted. Yet, this program is a live broadcast with continuity. So, this program is characterized in being unable to be rewound or paused to be viewed unless being recorded.

Yet, in case of VoD or AoD, a specific broadcast program, movie or music can be stored and then played later to be viewed. For instance, if a broadcast program is currently missed to view due to lack of time, a site providing the broadcast service is accessed to download a corresponding file or play the downloaded file directly. Likewise, the AoD provides a function of recording an audio program or playing an audio program by real time. MoD (music on demand) service enables a user to download a specific music to listen to. Targets of the MoD service can be implemented in a manner that a phonograph record manufacturer or distributor expands a conventional web service.

An embodiment of a service provided by a contents provider group is explained as follows.

First of all, a PF server can be serviced by a company that manages all broadcast information and location information provided by the contents provider. This service mainly contains location information necessary for a broadcast time or broadcast of a corresponding broadcasting station and information for enabling a customer to access the corresponding broadcasting station. The customer is able to obtain and display this information on a screen. The PF server is one of the services mandatory for each broadcasting station. In the IPTV environment, this service is provided to enable a customer to access a corresponding broadcasting station.

EPG service is one of convenient services provided to enable a customer to inquire a broadcast program per a time zone and recognize a broadcast program per a channel. The EPG service is configured to be executable in a manner that a corresponding program is automatically installed at a customer side in advance.

A customer is able to obtain the information for a corresponding broadcasting station only from a PF server. Yet, the EPG service enables a customer to obtain information for real-time broadcast channels of all broadcasting stations at a time. So, the EPG service can be very conveniently usable. For instance, the EPG service is provided with a powerful function of making a reservation for recording CNN news or a reservation for viewing Disney channel. So, the EPG service should provide details of information for broadcast programs in a corresponding area per a time zone. In particular, in case of a prescribed drama, contents of the drama are searched. The broadcast programs can be categorized into SF, drama, animation, and the like for discrimination. Detailed information for a story or characters of a movie or drama of a simple broadcast program can be included.

One big problem of the EPG service is how to transmit EPG data suitable for a customer due to too many kinds of licenses of customers who view IPTV. To access the EPG service, a customer finds and presses an input key of a remote controller with ease.

ECG service has all kinds of functions for facilitating a customer to use information for contents possessed by a contents provider, a location of an access server, an access authority and the like. In brief, the functions include a function of facilitating servers having contents to be accessed and an electronic program guide (EPG) indicating details of information for contents.

In particular, a load in individually accessing a prescribed content service to view or download contents can be reduced in a manner of binding services including AoD, MoD and VoD into one such as EPG except a real-time broadcast.

Similar to the EPG service, the ECG service enables contents stored in a server to be viewed at any time instead of informing real-time broadcast channel information. And, the ECG service enables contents to be downloaded and stored. If a customer attempts to access a server having corresponding contents, the customer has difficulty in obtaining an address or accessing PF servers. This is a very complicated process and consumes considerable time. A company providing ECG enables an ECG program to be automatically installed in a customer, collects information for all kinds of contents, and provides the corresponding data. In order to access an ECG service, a customer just clicks an input key button on a remote controller as well.

A portal server is connected to a broadcasting station via a web service provided by each broadcasting station or connected to a web server of a company servicing contents. The portal server plays a role in searching or viewing a program list provided by each broadcasting station or each contents provider providing a contents service. This can be considered as a function of ECG or EPG. Yet, a portal service is equipped with such a function as user authentication or license contract. So, an access is needed to view a specific program. Although ECG or EPG provides a unified broadcast or contents list, the portal service provides broadcast or contents list information for a corresponding program providing company to enable detailed search. In order to access a portal service, a customer just clicks a portal input button on a remote controller.

Thus, the contents provider side should include a function of providing those services and the like. If it is attempted to normally operate the functions, servers of service companies should be access IP network to transmit a corresponding program by real time or transmit broadcast information.

And, the respective broadcasting stations or the service companies should be connected to a network of a service provider for errorless transmission without delay. So, they should have a system for transmitting multimedia data using internet real-time protocol such as RTP, RTSP, RSVP, MPLS and the like.

For instance, in case that a TV studio currently providing news attempts to transmit multimedia by real time, if the multimedia includes MPEG-2 and AC-3 audio specifications, a transcoding work for converting them to fit a format of IPTV should be carried out. After a server for executing this work has been passed, a system is configured in a manner that RTP/UDP protocol including time information for matching caption or lip-sync is attached to pass through IP network provided by a service provider.

The service provider provides stability and bandwidth of network to enable multimedia data and broadcast data to be well transmitted by a contents provider. Service providers are able to provide IPTV services using a conventional cable network. In this case, equipments of delivery network need to be changed. In particular, network equipments capable of real-time data transmission should be provided for configuration and a customer should configure a network by considering a bandwidth. The equipments should reduce a bandwidth by processing massive multimedia data using a multicast service as a basic network service of IPTV. If a bandwidth is not secured, a service provider changes an optical cable network configuration or transcodes multimedia data from a contents provider into MPEG-4 or MPEG-7 formatted data with efforts to secure a bandwidth and then transmits the corresponding data. For this, the service provider should provide several kinds of services including NMS (network management system), DHCP (dynamic host control protocol), and CDN services.

The NMS service enables a service provider to manage a delivery network for a delivery to each customer and an IPTV receiver of the corresponding customer. In particular, in case that a broadcast reception is not available for a customer due to a technical difficulty of a delivery network, a means for emergency processing should be provided.

The NMS is widely used as a standardized means for controlling and managing machined in a remote transport layer. Using this service, it is able to check how many traffics are generated for a prescribed broadcast or which area is in short of bandwidth. The NMS service should be provided to contents providers to enable the corresponding contents provider to generate and manage groups in multicast. This is because more multicast groups may need to be generated occasionally.

The DHCP service enables an IP to be automatically allocated to an IPTV receiver of a customer and is used to inform an address of a CDN server. The DHCP service is a useful means for allocating IP to a PC on a general network. By transmitting an accessible address to an authorized IPTV receiver, a user is allowed to make a registration procedure for an initial access. Generally, an IPTV receiver will provide IPv4. Yet, IPv6 is also available. So, an IPTV receiver providing IPv4 is usable as well.

In the CDN service, when an IPTV receiver is initially operated with data provided by a service provider by receiving a power, CDN information is received from a service provider while IP is received by the DHCP service. This information contains customer registration or authentication of an IPTV provider and the above-explained PF informations. As an IPTV receiver obtains CDN information from a service provider, an IP broadcast signal reception is enabled.

A customer can have various kinds of IPTV receivers. A customer having a normal TV rents IPTV STB to enjoy an IPTV inexpensively. A service provider pays an additional service charge with a low price and a customer requests an IP phone to use together.

An IPTV receiver basically includes a network interface capable of accessing a network and has an Internet protocol. The IPTV receiver receives and processes data packets coming from a network and then plays multimedia data on a screen. In case of manipulating the IPTV receiver using a remote controller, the IPTV receiver should make a response by sending data packets quickly via a network to obtain corresponding information from a server. In particular, the IPTV receiver is capable of operating to transmit user requested items bi-directionally while processing multimedia data. And, buttons for IPTV can be provided to a remote controller to use the corresponding service well. So, a consumer is able to store and view a fine scene of a drama in the above-provided IPTV receiver and enjoy additional services including location information, hotel reservation and the like.

Meanwhile, the above-mentioned NMS includes the function that a service provider manages a network. And, the NMS helps the service provider control and manage an IPTV receiver of a consumer. If more IPTV receivers are used and if more additional services are provided, the role of the NMS becomes more important. So, SNMP protocol becomes mandatory for an IPTV broadcast receiver. This is intended for a service provider to manage and control an IPTV broadcast receiver. If so, an IPTV broadcast receiver is able to obtain details of statistical data of a currently communicating protocol, information for a currently used processor, information for a TV manufacturer, and the like.

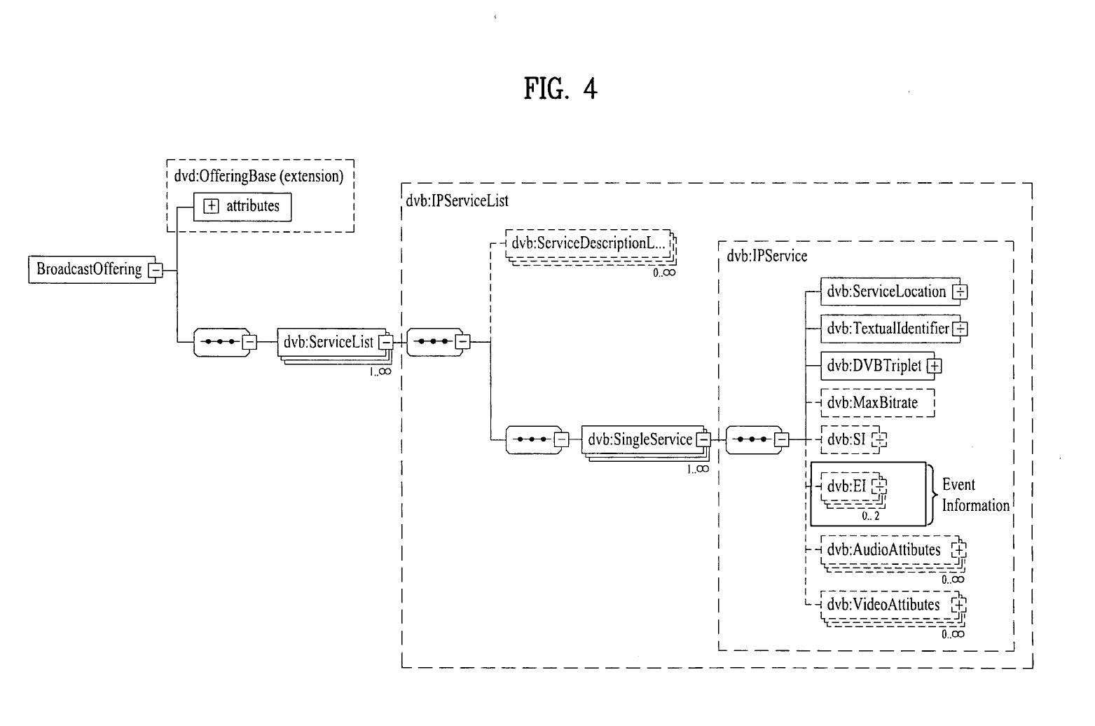

FIG. 4 is a block diagram of a system between a service provider and a broadcast receiver.

Referring to FIG. 4, a terminal o a service provider is capable of bi-direction communication via an IP network. In particular, according to the present system, a broadcast receiver is capable of receiving a broadcast from a service provider and also capable of transmitting information for an environment of the broadcast receiver to the service provider.

In this case, when the service provider collects to provide broadcast signals to the broadcast receiver, a broadcast stream can include a single or multi program. In case of attempting to transmit a transport stream via an IP network, IP capsulation is required.

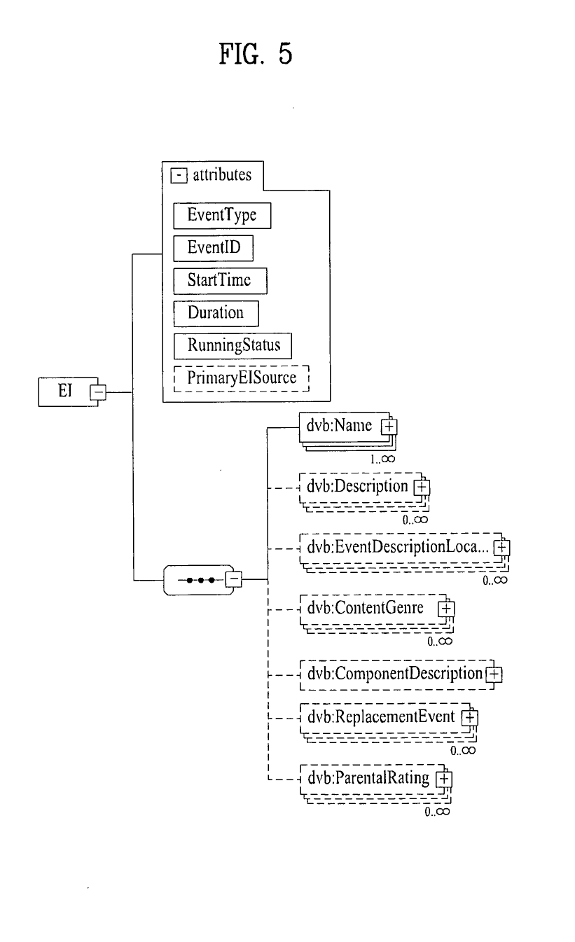

FIG. 5 is a diagram for IP capsulation in case that a service provider provides a service to a broadcast receiver via an IP network.

Referring to FIG. 5, an IP capsule can include an IP header, a UDP header, an RTP header, and real data, i.e., a transport stream packet.

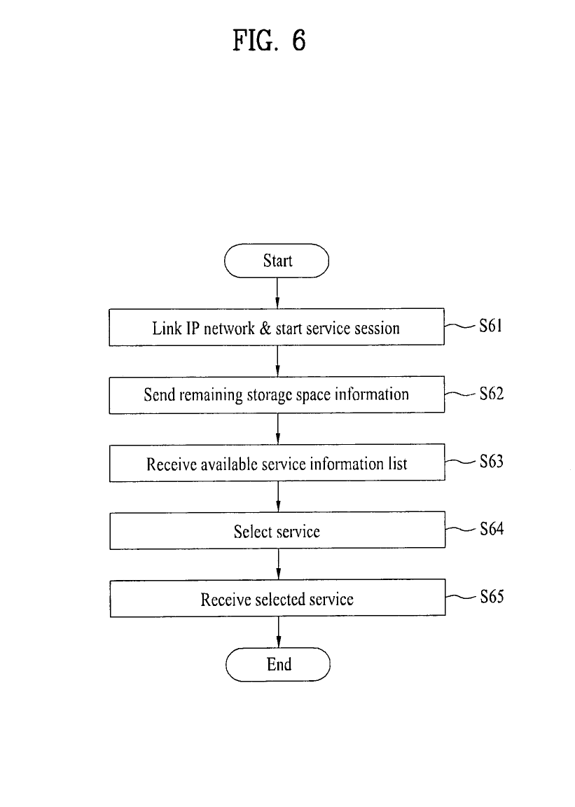

FIG. 6 is a flowchart for a method of receiving an adaptive broadcast signal according to a first embodiment of the present invention.

Referring to FIG. 6, a method of receiving an adaptive broadcast signal according to the present invention includes the steps of linking an IP network and opening a service session on the IP network, sending remaining storage space information of the broadcast receiver to a service provider via the linked IP network, receiving an available service information list provided by the service provider based on the sent remaining storage space information, and if at least one service is selected from the received available service information list, receiving the selected service.

In the step S61 of linking an IP network and opening a service session on the IP network, a terminal is connected to the service provider via the IP network and the corresponding session is opened. In this case, the terminal is preferentially connected to the service provider specified as default and the session can be then opened. In case that the terminal is subscribed in a plurality of service providers, it is able to select the service provider to be connected.

In the step S62 of sending remaining storage space information of the broadcast receiver to a service provider via the linked IP network, to be provided with a service suitable for a remaining storage service of the receiver, the remaining storage space information is sent to the service provider.

In this case, the remaining storage space information may mean the information on a storage capacity resulting from subtracting a storage capacity in use from a total storage capacity of the receiver or may mean the information on a storage capacity capable of storing a service received by the receiver from the service provider. In particular, the remaining storage space information can represent a remaining storage space of a storage device of the broadcast receiver by a predetermined unit.

In the step S63 of receiving an available service information list provided by the service provider based on the sent remaining storage space information, the service provider sends a list of information on various versions of contents suitable for the remaining storage space of the receiver to the receiver based on the remaining storage space information having sent to the service provider.

For instance, the service provider sends the receiver a list of at least one version of contents retained by the service provider. In this case, it is able to send a list including a service having a bitrate suitable for a storage space according to the storage space of the broadcast receiver.

In particular, in case that a storage space is small, it is able to send a list including a service having a low bitrate. In case that a storage space is sufficiently large, it is able to send a list including a service having a high bitrate as well as a service having a low bitrate. Moreover, depending on a storage space of the broadcast receiver, it is able to enable a user to make a selection by sending a list including both HD service and SD service. Optionally, it is able to send a list including SD service storable in the receiver only.

If the user selects a program from the received available service information list [S64], the service provider provides the user with the selected program [S65]. If the user selects a specific version of the program to view from the received list, the service provider provides the corresponding service based on an inputted selection signal.

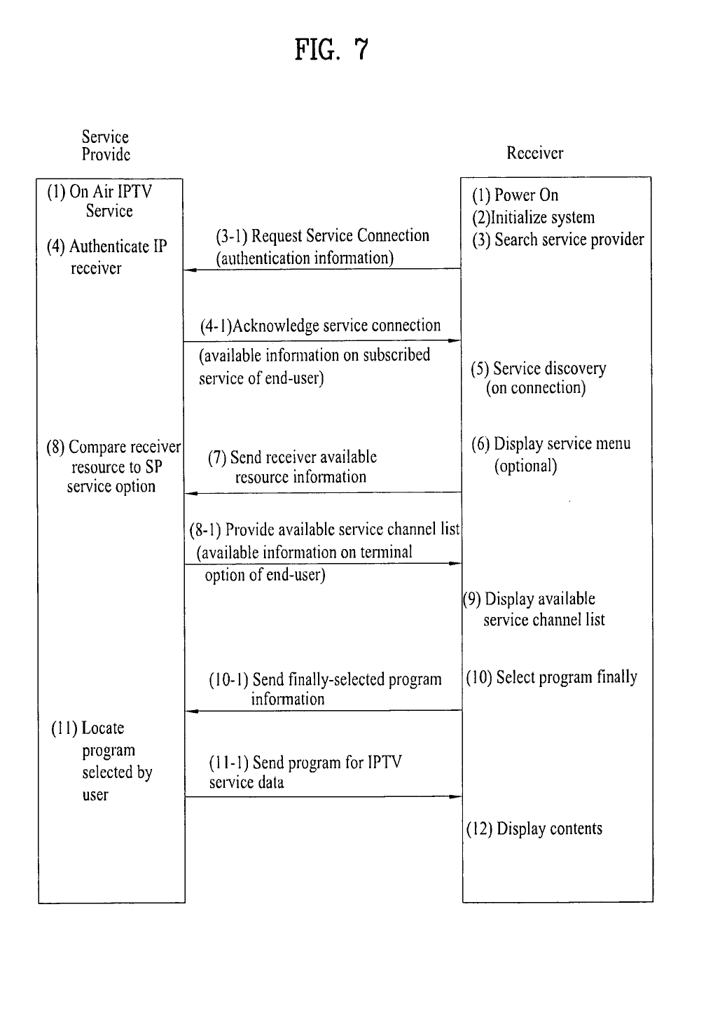

FIG. 7 is a diagram for operations between a service provider and a broadcast receiver according to one preferred embodiment of the present invention in a method of receiving an adaptive broadcast signal according to a first embodiment of the present invention.

A broadcast signal receiving method between a service provider and a broadcast receiver is explained with reference to FIG. 7 as follows. The respective steps of the following description are exemplary for the embodiment, by which the claims of the present invention are non-limited according to the steps or temporal sequence of the following description.

First of all, while a service provider is providing a broadcast service [1], a power of a broadcast receiver is turned on [1]. If the power of the broadcast receiver is turned on, system initialization is performed [2]. The system-initialized broadcast receiver searches service providers for a connectable service provider [3] and may be connected to a service provider set to a default. If a plurality of connectable service providers exist, the receiver makes a request for a user to make a selection. The user is then able to make a selection for the corresponding connectable service provider.

While the receiver makes the service connection to the service provider, it sends authentication information of the receiver (3-1). The service provider having received the authentication information of the receiver performs receiver authentication [4].

If the qualification of the receiver is authenticated in the authenticating step, the service provider sends a service connection acknowledgement [4-1]. In this case, the service provider sends availability on a subscribed service with the service connection acknowledgement. The availability information on the subscribed service means the available service information of a receivable physical channel.

The receiver performs a service discovery [5]. This is the step of searching services and determining service characteristics. Through this step, the receiver is connected to the service provider. The receiver displays a service menu [6] to show an available service on the subscribed services to the user.

The receiver sends its available resource information to the service provider [7]. In this case, the available resource information can include at least one selected from the group consisting of resolution information, audio codec information, video codec information, network information, user level information and remaining storage space information.

Having received the available resource information, the service provider compares various versions of a content to the remaining storage space information included in the available resource information [8]. As a result of the comparison, the service provider sends the receiver an available service channel list outputtable from the receiver [8-1]. In particular, the service provider sends available information on the receiver option.

Having received the available service list from the service provider, the receiver displays the available service list [9]. The user then selects at least one available service from the available service list [10]. In doing so, the user selects a specific channel to view from the available service list and also selects a content version having a specific bitrate from contents of the same channel. In this case, it is able to send channel selection information in the step [7] of sending the remaining storage space information of the receiver. If so, the service provider is able to provide an available service version list for the selected channel.

If the selected program information is sent to the service provider [10-1], the service provider searches services for the service selected by the user [11] and then provides the searched service to the receiver [11-1].

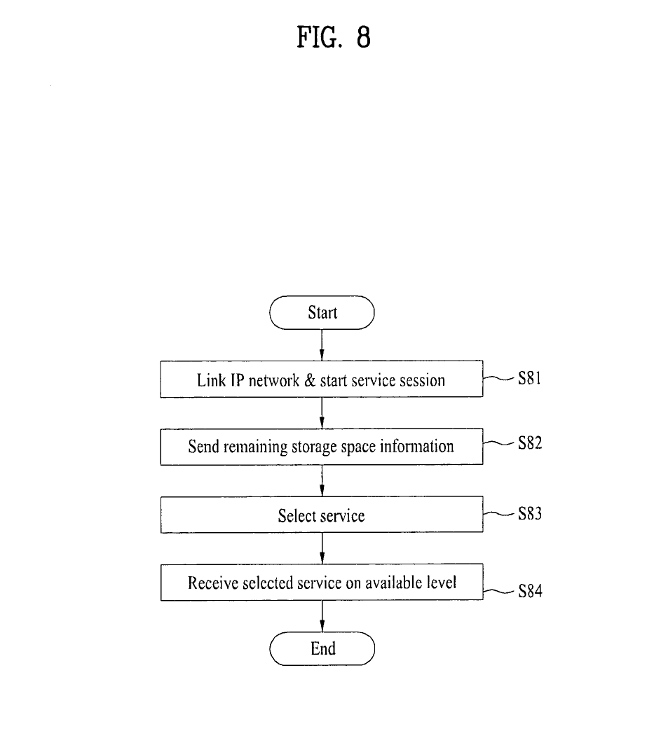

FIG. 8 is a flowchart for a method of receiving an adaptive broadcast signal according to a second embodiment of the present invention.

Referring to FIG. 8, a method of receiving an adaptive broadcast signal according to the present invention includes the steps of linking an IP network and opening a service session, sending remaining storage space information of the broadcast receiver and program selection information to a service provider via the linked IP network, and receiving at least one service in an available service information on a program selected by a user.

The step of linking the IP network and the step of sending remaining storage space information of the broadcast receiver to a service provider are identical to those of the first embodiment of the present invention. Yet, the second embodiment of the present invention differs from the first embodiment of the present invention in selecting a service version or a service having a suitable bitrate based on the receiver's remaining storage space information provided by the service provider of the receivers instead of selecting a service to be provided to the user from an available service list and then sending the selected suitable service version or the selected service having the suitable bitrate to the receiver.

The step S82 of sending the remaining storage space information of the receiver to the service provider and the step S83 of selecting the program to be viewed by the user can be performed together or separately.

In particular, both of the remaining storage space information and the program selection information, i.e., channel information are sent to the service provider. For instance, if the user selects a channel number ‘10’ and the remaining storage space information is provided together with the selected channel number.

The service provider selects at least one of the available services and then provides the selected at least one available service to the receiver [S84]. In doing so, the service provider is able to send the service selected by the user in a manner of adjusting the selected service to have a suitable bitrate based on the received remaining storage space information. Moreover, the service provider selects a suitable version of a service selected by a user from an SD version and an HD version based on the received remaining storage space information and is then able to send the selected version of the service to the user.

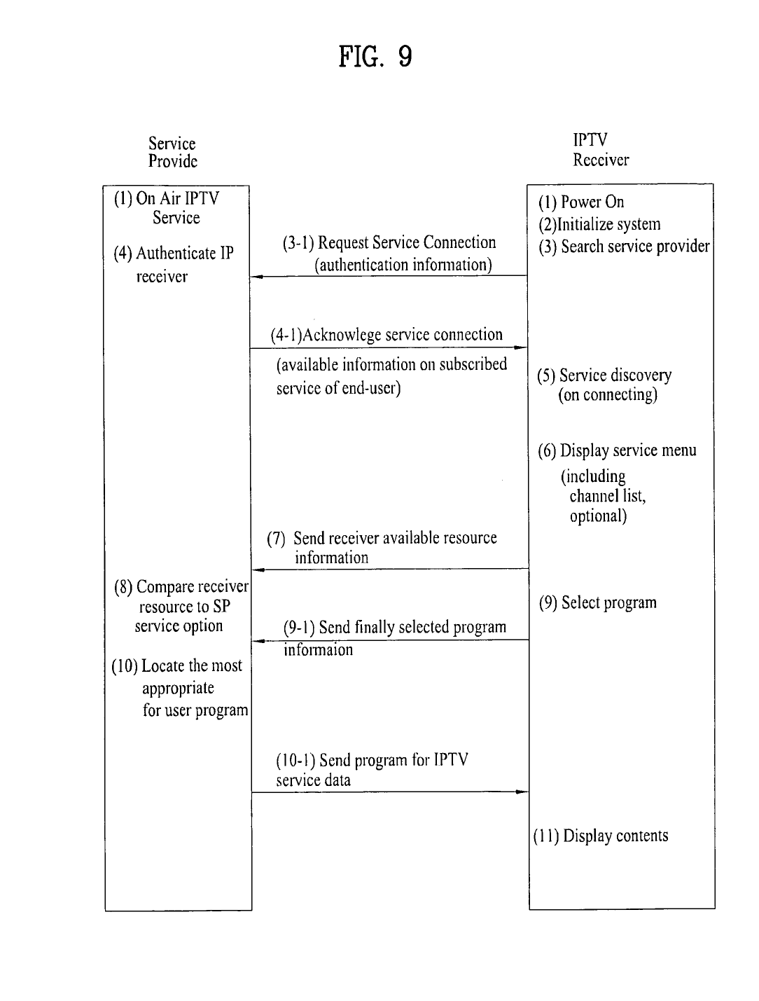

FIG. 9 is a diagram for operations between a service provider and a broadcast receiver according to one preferred embodiment of the present invention in a method of receiving an adaptive broadcast signal according to a second embodiment of the present invention.

A broadcast signal receiving method between a service provider and a broadcast receiver is explained with reference to FIG. 9 as follows. The respective steps of the following description are exemplary for the embodiment, by which the claims of the present invention are non-limited according to the steps or temporal sequence of the following description.

First of all, the process including the steps [1] to (6) is identical to that of the first embodiment. Hence, a process next to the step [6] is explained in the following description for the second embodiment of the present invention.

The receiver sends its available resource information to the service provider [7]. In this case, the available resource information can include at least one selected from the group consisting of resolution information, audio codec information, video codec information, network information, user level information and remaining storage space information.

Having received the available resource information, the service provider compares various versions of a retained content to an option of the remaining storage space information included in the available resource information [8]. The receiver receives an input of a program selection signal of a user [9] and then sends finally-selected program selection information to the service provider [9-1]. In this case, both of the program selection and the selection signal transmission to the service provider in the receiver can be performed prior to the option comparison step [8] in the service provider. Moreover, the transmission [6] of the available resource information can be performed together.

In particular, the remaining storage space information is sent [7], the corresponding options are compared [8], and the finally-selected program selection information can be then sent. Alternatively, after the remaining storage space information and the finally-selected program information have been sent, the option comparison can be performed on the retained content for the selected program.

If the selected program information is sent to the service provider [9-1], the service provider discovers a content version having a bitrate closest to a remaining storage space as a result of the option comparison for the selected program [10] and then provides the discovered content to the receiver [10-1]. Finally, the broadcast receiver provided with the content by the service provider displays the received content [11].

In the first embodiment, if the remaining storage space information of the receiver is provided to the service provider, the service provider sends the available service information list to the receiver. And, the user selects a service version to be finally outputted or a content bitrate. In particular, the service version to be outputted or the content bitrate is selected by the user.

On the contrary, in the second embodiment, if the remaining storage space information of the receiver is provided to the service provider, the service provider selects a service closest to the remaining storage space and then provides the selected service to the receiver. In particular, the service version to be outputted or the content bitrate is selected by the service provider.

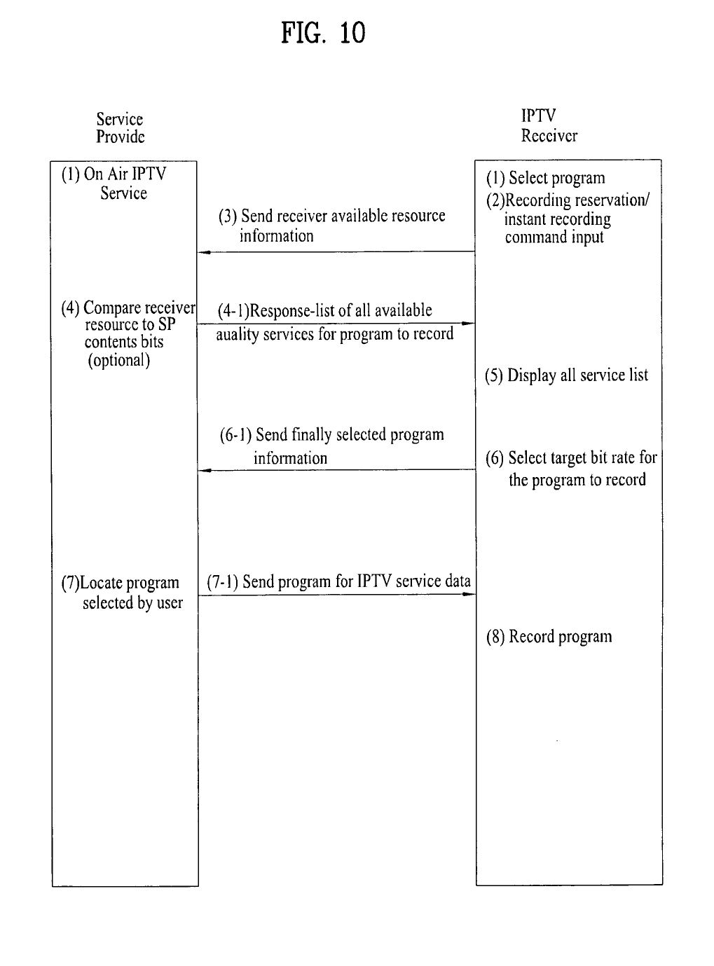

FIG. 10 is a diagram for operations between a service provider and a broadcast receiver according to another preferred embodiment of the present invention in a method of receiving an adaptive broadcast signal according to a first embodiment of the present invention.

Referring to FIG. 10, a service provider is providing a broadcast service [1]. A broadcast receiver receives a selection of a program selected by a user [1] and also receives an input of a recording reservation or instant recording command for the selected program [2]. The broadcast receiver sends available resource information in the receiver to the service provider [3]. In this case, the available resource information can include at least one selected from the group consisting of resolution information, audio codec information, video codec information, network information, user level information and remaining storage space information.

Having received the available resource information, the service provider compares various versions of its retained content to remaining storage space information included in the available resource information [4]. As a result of the comparison, the service provider sends the receiver an available service channel list outputtable from the receiver [4-1]. In particular, the service provider sends available information on receiver options. In this case, the available service list can include size information of a transmitted program. In case that recording is performed in the course of program viewing, the available service list includes information indicating a size corresponding to a remaining time of the program.

Having received the available service list from the service provider, the receiver displays the available service list [5]. The broadcast receiver displays the corresponding service even if it is unable to record the corresponding service to its end due to the limited storage space. And, the broadcast receiver is able to selectively display availability or unavailability of the recording together with the available service list.

The user selects at least one service from the available service list [6]. In this case, the user is able to select a service that provides a specific recordable program version from the available service list. And, the user is able to select a program version having a specific bitrate. In doing so, the program selection information can be sent together in the step [3] of sending the remaining storage space information of the receiver. In this case, the service provider is able to provide an available service version list for the selected program.

If the selected program information is sent to the service provider [6-1], the service provider discovers the program selected by the user [7] and then provides the discovered program to the receiver [7-1].

Having received the content provided by the service provider, the broadcast receiver records the received content [8].

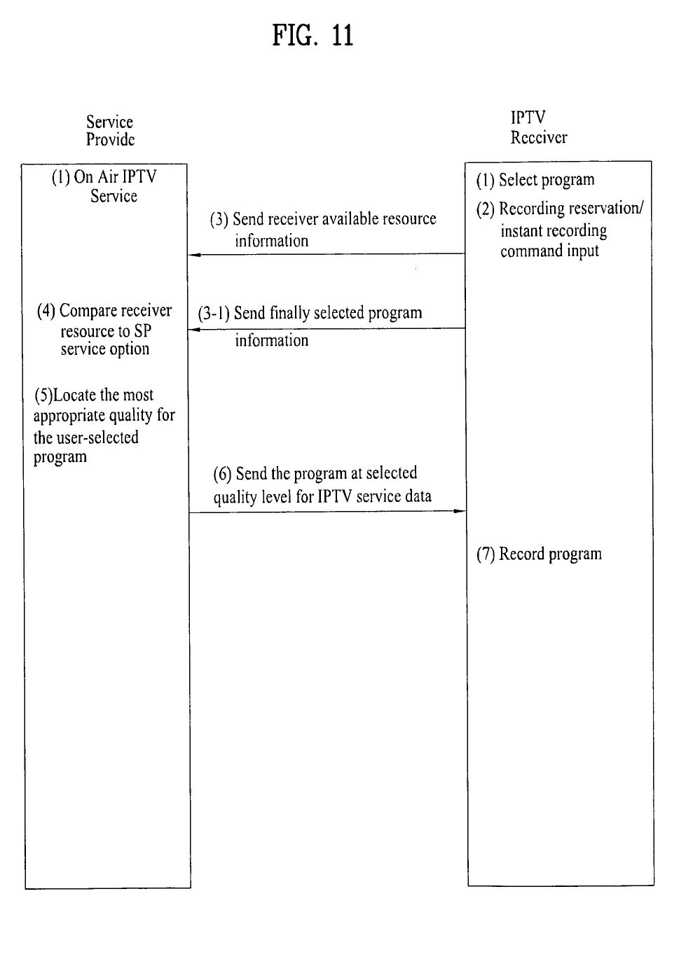

FIG. 11 is a diagram for operations between a service provider and a broadcast receiver according to another preferred embodiment of the present invention in a method of receiving an adaptive broadcast signal according to a second embodiment of the present invention.

Referring to FIG. 11, a service provider is providing a broadcast service [1]. A broadcast receiver receives a selection of a program selected by a user [1] and also receives an input of a recording reservation or instant recording command for the selected program [2]. The broadcast receiver sends available resource information in the receiver to the service provider [3]. In this case, the available resource information can include at least one selected from the group consisting of resolution information, audio codec information, video codec information, network information, user level information and remaining storage space information.

Having received the available resource information, the service provider compares various versions of its retained content to options of remaining storage space information included in the available resource information [4]. The broadcast receiver sends finally-selected program selection information, for which a program selection signal is inputted by a user, to the service provider [3-1]. In this case, the program selection in the broadcast receiver and the selection signal transmission to the service provider can be performed before the option comparing step [4] in the service provider. And, they can be performed together with the transmission [3] of the available resource information.

In particular, the available resource information is sent [3], the corresponding options are compared [4], and the finally-selected program selection information can be then sent. Alternatively, after the available resource information and the finally-selected program information have been sent, the option comparison can be performed on the retained content for the selected program.

If the selected program information is sent to the service provider [3-1], the service provider discovers a content version having a bitrate closest to a remaining storage space as a result of the option comparison for the selected program [5] and then provides the discovered content to the receiver [6]. In this case, the service provider is able to provide an adaptive bitrate for the whole program or can provide an adaptive bitrate service by a section unit. In particular, it is able to apply a target rate to differ by a predetermined time unit for the same program. If so, it is able to adaptively apply the target bitrate by the section unit with reference to the storage space information sent by a receiving device.

For instance, in case of a folk song program, the program is sent at a high bitrate for a section in which a specific singer appears. And, the rest part of the program is transmitted by being coded at a low bitrate. Thus, it is able to provide the adaptive bitrate service by the section unit. In this case, the overall bitrate for the program is adjustable according to a remaining storage space size of the broadcast receiver.

Formula 1 is provided to calculate the target bitrate.

Target bitrate=(Hbit*L1/Len)+(Lbit*L2/Len) [Formula 1]

In Formula 1, ‘Hbit’ indicates a bitrate for a high bitrate section, ‘Lbit’ indicates a bitrate for a low bitrate section, ‘L1’ indicates a time length (unit of second) for the low bitrate section, and ‘Len’ indicates a total time length (unit of second) for a program.

Having received the content provided by the service provider, the broadcast receiver records the received content [7].

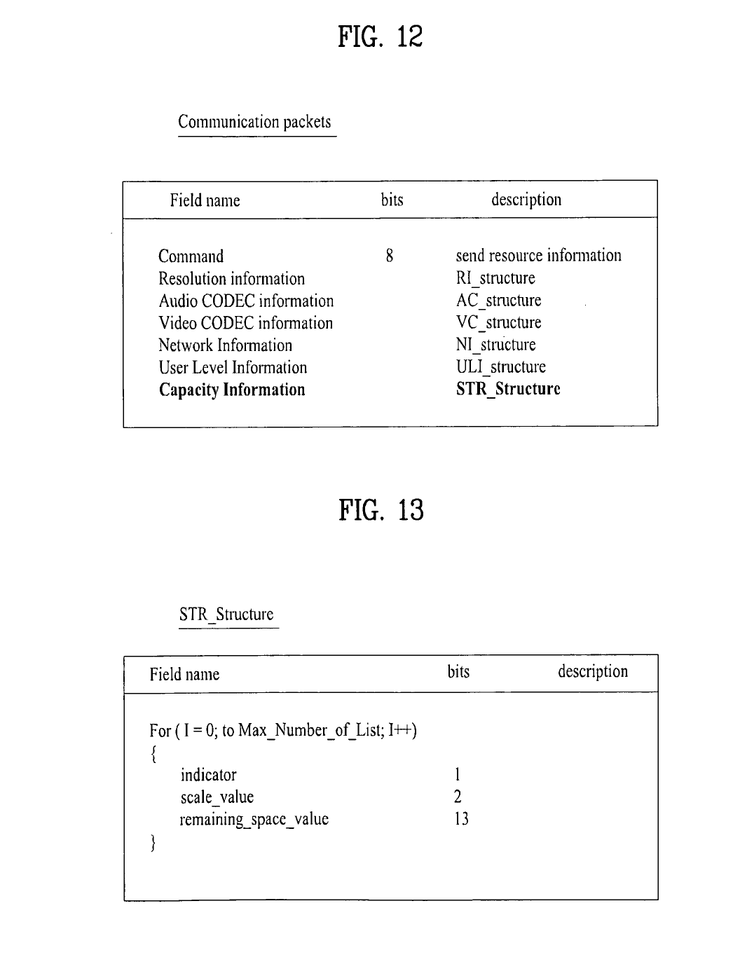

FIG. 12 is a diagram of a data structure for sending resource information of a broadcast receiver to a service provider from the broadcast receiver according to one embodiment of the present invention.

Referring to FIG. 12, communication packets are the packets to carry resource information of a broadcast receiver to a service provider from a broadcast receiver and include a command field, a resolution information field, an audio CODEC information field, a video CODEC information field, a network information field, a user level information field and a capacity information field. The command field includes request information, the resolution field includes resolution information, and the audio CODEC information field includes audio codec information. The video CODEC information field includes video codec information, the network information field includes network information, and the user level information field includes user level information. And, the capacity information field includes remaining storage space information.

In this case, remaining storage space information can be the information that indicates a remaining space of a storage device of a broadcast receiver by a predetermined unit. The remaining storage space information can be sent only if the broadcast receiver has the remaining storage space equal to or smaller than a predetermined value.

Since the broadcast receiver does not always sends the information to the service provider, an indicator field indicating whether valid information is included can be included in the capacity information field. For instance, if a bit of the indicator field is set to ‘1’, it can be negotiated to send the remaining storage space information.

In the embodiments shown in FIG. 7 and FIG. 10, the service provider enables a size of a program provided via each service to be included in the capacity information field and is then able to send the available channel list in which the capacity information field is included. If a program is produced in advance, information containing a measured size of the program is sent. If a program is a real-time broadcast, information, which is predicted using a target bitrate and a program length, is sent. In the embodiments shown in FIG. 8 and FIG. 11, it is able to provide the capacity information to the service provider from the broadcast receiver, and vice versa.

FIG. 13 is a diagram of a data structure for sending remaining storage space information of a broadcast receiver to a service provider from the broadcast receiver according to one embodiment of the present invention.

Referring to FIG. 13, STR data structure is the data structure to carry remaining storage space information. For this, an indicator field, a scale_value field and a remaining_space_value field can be included. In this case, the indicator field is the field for signaling to send remaining storage space information. If the indicator is set to ‘1’, it indicates a case that the receiver starts the recording, a case that a push VOD service is initiated, a case that a storage space remains equal to or smaller than a remaining storage space shortage threshold determined by the receiver itself, or the like. And, the scale_value field and the remaining_space_value field are the fields to indicate a remaining storage space capacity. The remaining storage space capacity or a program size (program_size_in_bytes) can be calculated from Formula 2.

Proram_size_in_bytes=remaining_space_vale*scale [Formula 2]

In Formula 2, ‘scale’ can be calculated from Formula 3.

Scale=10̂scale_value*1 Mbytes. [Formula 3]

According to Formula 2 and Formula 3, when scale_value is 0, a maximum value of Proram_size_in_bytes, which can be represented by STR_Structure, is 8 Gbytes. When scale_value is 1, a maximum value of Proram_size_in_bytes, which can be represented by STR_Structure, is 80 Gbytes. When scale_value is 2, a maximum value of Proram_size_in_bytes, which can be represented by STR_Structure, is 800 Gbytes. When scale_value is 3, a maximum value of Proram_size_in_bytes, which can be represented by STR_Structure, is 80 Tbytes.

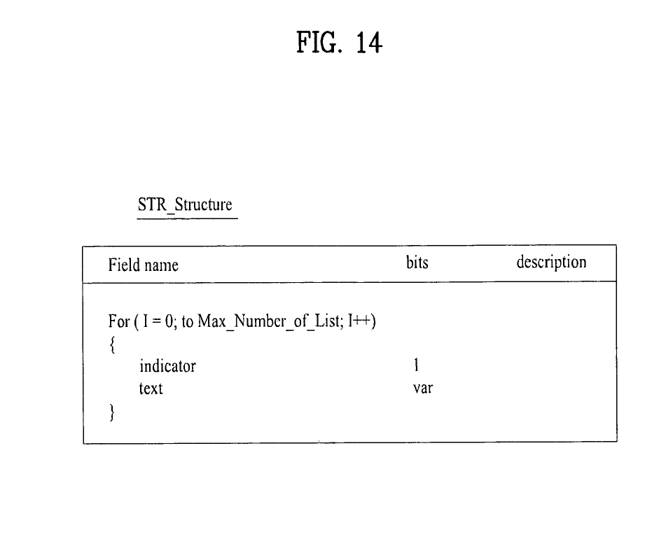

FIG. 14 is a diagram of a data structure for sending remaining storage space information of a broadcast receiver to a service provider from the broadcast receiver according to another embodiment of the present invention.

Referring to FIG. 14, STR data structure can include an indicator field and a text field. In this case, the indicator field is the field for signaling to send remaining storage space information. If the indicator is set to ‘1’, it indicates a case that the receiver starts the recording, a case that a push VOD service is initiated, a case that a storage space remains equal to or smaller than a remaining storage space shortage threshold determined by the receiver itself, or the like. And, the text field is the field to indicate a remaining storage space capacity. The text field can indicate 4 G in a text format if the remaining storage space capacity is 4 Gbytes.

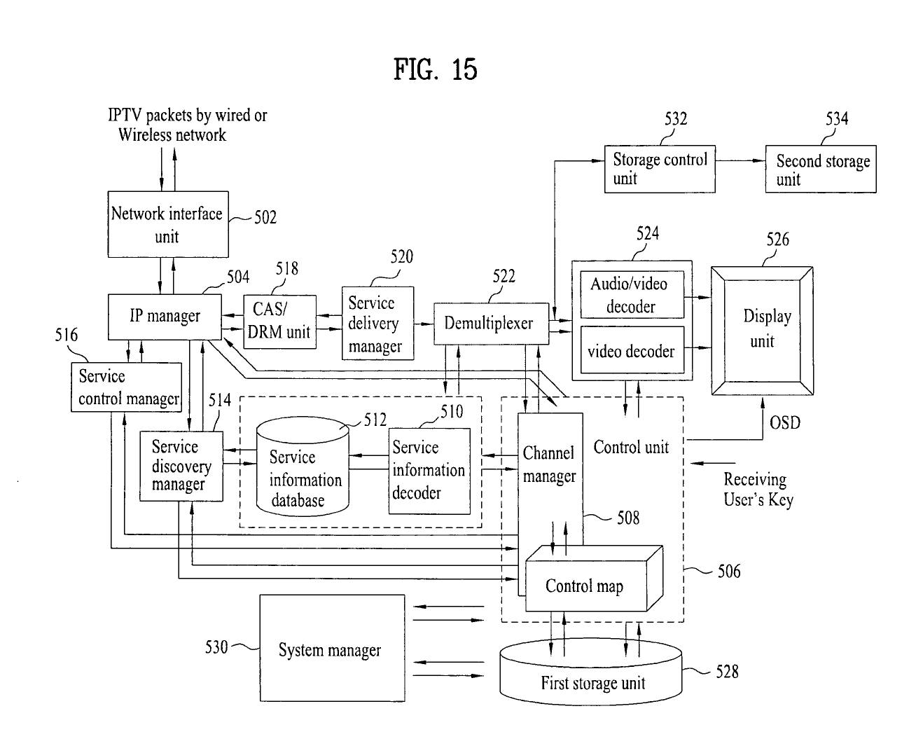

FIG. 15 is a block diagram of a broadcast receiver according to an embodiment of the present invention.

Referring to FIG. 5, an adaptive broadcast receiver according to the present invention includes a network interface unit transmitting/receiving an IP packet by connecting the broadcast receiver to a service provider via a network, a display unit outputting a broadcast signal received by the network interface unit, and a control unit controlling remaining storage space information to be sent to the service provider, the control unit controlling an adaptive broadcast signal based on the sent remaining storage space information to be displayed or stored.

Detailed configuration of the broadcast receiver is explained as follows. First of all, the receiver includes a network interface unit 502, an IP manager 504, a control unit 506, a channel manager 508, a service information decoder 510, a service information database 512, a service discovery manager 514, a service control manager 516, a CAS/DRM unit 518, a service delivery manager 520, a demultiplexer 522, an audio/video decoder 524, a display unit 526, a first storage unit 528, a system manager 530, a storage control unit 532 and a second storage unit 534.

The network interface unit 502 receives packets received from a network and transmits packets from the receiver via the network. In particular, the network interface unit 502 receives an adaptive broadcast signal of the present invention from a service provider according to the present invention via the network.

The IP manager 504 manages the packet delivery from a source to a destination for a packet received by the receiver and a packet transmitted by the receiver. The IP manager 504 sorts the received packets to correspond to an appropriate protocol and then outputs the sorted packets to the service control manager 516, the service discovery manager 514 and the CAS/DRM unit 518. For instance, the IP manager 504 is able to deliver the packet containing remaining storage space information to the service provider.

The control unit 506 controls an application and controls overall operations of the receiver according to a user's input signal by controlling the user interface (not shown in the drawing). The control unit 506 provides a graphic user interface (GUI) for user using OSD (on screen display) and the like. The control unit 506 receives an input signal from a user and then performs a receiver operation according to the input. For instance, in case of receiving a key input for a channel selection from a user, the control unit 506 transfers the channel selection input signal to the channel manager. In case of receiving a key input for a specific service selection included in an available service information list from a user, the control unit 506 transfers the service selection input signal to the channel manager 508.

The control unit 506 controls the remaining storage space information of the second storage unit 534 to be transferred to the service provider. The control unit 506 controls an adaptive broadcast signal, which is based on the transferred remaining storage space information, to be displayed. In this case, the control unit 506 is able to receive an input of the remaining storage space information from the storage control unit 532, converts the inputted remaining storage space information to the STR_Structure format shown in FIG. 13 or FIG. 14, and control it to be transferred to the service provider by including it in the capacity information field of the communication packets shown in FIG. 12.

The channel manager 508 generates a channel map by storing received channel information. The channel manager 508 selects a channel or a service according to a key input received from the control unit 506 and controls the service discovery manager 514.

The channel manager 508 receives service information of a channel from the service information decoder 510 and then performs audio/video PID (packet identifier) setting of the selected channel and the like on the demultiplexing unit (demultiplexer) 522.

The service information decoder 510 decodes such service information as PSI (program specific information) and the like. In particular, the service information decoder 510 receives the demultiplexed PSI table, PSIP (program and service information protocol) table, DVB-SI (service information) table and the like from the demultiplxer 522 and then decodes the received tables.

The service information decoder 510 generates a database relevant to service information by decoding the received service information tables and then stores the database relevant to the service information in the service information database 512.

The service discovery manager 514 provides information required for selecting a service provider, who provides a service, and information required for receiving a service. In particular, the service discover manager 514 receives a service discovery record, parses the received service discovery record, and then extracts information required for selecting a service provider and information required for receiving a service. In case of receiving a signal for a channel selection from the control unit 506, the service discovery manager 514 discovers a service provider using the information.

The service control manager 516 is responsible for selection and control of a service. For instance, if a user selects a live broadcasting service according to a conventional broadcasting system, the service control manager 516 performs the service selection and control using IGMP or RTSP. If a user selects such a service as VOD (video on demand), the service control manager 516 performs the service selection and control using RTSP. In this case, the RTSP (real-time streaming protocol) can provide a trick mode for real-time streaming.

The service relevant packet received via the network interface unit 502 and the IP manager 504 is transferred to the CAS/DRM unit 518. The CAS/DRM unit 518 is responsible for a control access system (CAS) and digital rights management (DRM) of service.

The service delivery manager 520 is responsible for the control of received service data.

For instance, in case of controlling real-time streaming data, RTP/RTCP (real-time transport protocol/RTP control protocol) is used. In case that the real-time streaming data is transported using the RTP, the service delivery manager 520 parses the received data packet according to the RTP and then transfers the parsed packet to the demultiplexer 522. The service delivery manager 520 feeds back the network reception information to a sever that provides a service using the RTCP. In doing so, the real-time streaming data is directly delivered by being encapsulated with UDP without RTP.

The demultiplexer 522 demultiplexes the received packet into audio data, video data, PSI (program specific information) data and the like and then transfers them to the video/audio decoder 524 and the service information decoder 510, respectively. Moreover, the demultiplexer 522 transfers the demultiplexed data to the storage control unit 532 to enable the demultiplexed data to be recorded under the control of the controller 508.

The audio/video decoder 524 decodes the audio and video data received from the demultiplexer 522. The audio/video data decoded by the audio/video decoder 524 are provided to a user via the display unit 526.

The first storage unit 528 stores setup data of system and the like. In this case, the first storage unit 528 can include a non-volatile memory (non-volatile RAM: NVRAM), a flash memory or the like.

The system manager 530 controls overall operations of the receiver system via power.

The storage control unit 532 controls the recording of the data outputted from the demultiplexer 522. In particular, the storage control unit 532 stores the data outputted from the demultiplexer 532 in the second storage unit 534. The storage control unit 532 manages a storage space of the second storage unit 534. The storage control unit 534 calculates remaining storage space information and is then able to provide the calculated information to the control unit 508.

The second storage unit 534 stores the received content under the control of the storage control unit 532. In particular, the second storage unit 534 stores the data outputted from the demultiplexer 522 under the control of the storage control unit 532. In this case, the second storage unit 532 can include such a non-volatile memory as HDD and the like. Moreover, a content having a different bitrate per region can be recorded in the second storage unit 532 according to a remaining storage space capacity of the second storage unit 532.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of receiving an adaptive broadcast signal, comprising the steps of:
sending an available service information list including size information of a program broadcasted by a service provider via an IP network;
receiving and displaying the sent available service information list;
selecting a target bitrate from the size information of the program included in the received available service information list;
sending the selected target bitrate to the service provider; and
broadcasting the program having the sent target bitrate from the service provider.

2. The method of claim 1, further comprising the step of sending remaining storage space information to the service provider.

3. The method of claim 2, wherein if a remaining storage space equal to or lower than a preset value exists, the remaining storage space information is sent.

4. The method of claim 1, wherein in the step of sending the available service information list, the available service information list is sent in at least one case selected from the group consisting of a push VOD (video on demand) service execution, a specific broadcast program broadcasting start and a specific program recording execution.

5. A method of receiving an adaptive broadcast signal, comprising the steps of:
receiving an available service information list including size information of a program broadcasted from a service provider via an IP network;
displaying the received available service information list;
selecting a target bitrate from the size information of the program included in the received available service information list;
sending the selected target bitrate to the service provider; and
receiving the program having the sent target bitrate.

6. The method of claim 5, further comprising the step of sending remaining storage space information to the service provider.

7. The method of claim 6, wherein if a remaining storage space equal to or lower than a preset value exists, the remaining storage space information is sent.

8. The method of claim 5, wherein in the step of receiving the available service information list, the available service information list is received in at least one case selected from the group consisting of a push VOD (video on demand) service execution, a specific broadcast program broadcasting start and a specific program recording execution.

9. A method of receiving an adaptive broadcast signal, comprising the steps of:
sending remaining storage space information to a service provider via an IP network;
sending recording target program information to the service provider;
selecting a target bitrate of the recording target program based on the sent remaining storage space information in the service provider; and
broadcasting the program having the selected target bitrate from the service provider.

10. The method of claim 9, wherein the broadcasted program has an adaptive bitrate by a section unit.

11. A method of receiving an adaptive broadcast signal, comprising the steps of:
sending remaining storage space information to a service provider via an IP network;
sending recording target program information to the service provider; and
receiving a program having a target bitrate selected based on the sent remaining storage space information in the service provider.

12. The method of claim 11, wherein the received program has an adaptive bitrate by a section unit.

13. A broadcast receiver comprising:
a network interface unit transmitting/receiving an IP packet via a network;
a display unit displaying a broadcast signal included in the IP packet;
a control unit controlling an available service information list including size information of a program broadcasted from a service provider to be displayed, the available service information list included in the IP packet, the control unit selecting a target bitrate from the size information included in the available service information list, the control unit controlling the selected target bitrate to be sent to the service provider; and
a service control manager controlling a reception of the program having the sent target bitrate.

14. The broadcast receiver of claim 13, further comprising a storage unit storing the program having the sent target bitrate.

15. The broadcast receiver of claim 14, wherein the control unit controls remaining storage service information of the storage unit to be sent to the service provider.

16. The broadcast receiver of claim 15, wherein if a remaining storage space equal to or lower than a preset value exists, the control unit controls the remaining storage space information to be sent.

17. The broadcast receiver of claim 13, wherein the available service information list is received in at least one case selected from the group consisting of a push VOD (video on demand) service execution, a specific broadcast program broadcasting start and a specific program recording execution.

18. The broadcast receiver of claim 13, wherein the control unit selects the target bitrate from the size information included in the available service information list based on a user's program selection signal.

19. A broadcast receiver comprising:
a network interface unit transmitting/receiving an IP packet via a network;
a display unit displaying a broadcast signal included in the IP packet;
a control unit controlling remaining storage space information of the storage unit and recording target program information to be sent to a service provider; and
a service control manager controlling a reception of a program having a target bitrate selected based on the remaining storage space information.

20. The broadcast receiver of claim 19, wherein the program has an adaptive bitrate by a section unit.
